(19) United States
(12) Patent Application Publication
(10) Pub. No.: US 2005/0169161 A1
(43) Pub. Date: Aug. 4, 2005

(54) Information recording medium

(75) Inventor: Kazuo Kuroda, Tokorozawa-shi (JP)

Correspondence Address: YOUNG & THOMPSON, 745 SOUTH 23RD STREET, 2ND FLOOR, ARLINGTON, VA, 22202, US

(73) Assignee: PIONEER CORPORATION, TOKYO (JP)

(21) Appl. No.: 11/048,734

(22) Filed: Feb. 3, 2005

(30) Foreign Application Priority Data
Feb. 3, 2004 (JP) 2004-026707

(51) Int. Cl. G11B 7/24

(52) U.S. Cl. 369/275.4; 369/275.3

(57) ABSTRACT

An information recording medium provided with: a wobble track, which wobbles at a predetermined reference cycle, for controlling rotation of the medium; and a reference recording speed, which is a standard when record information is recorded, being N times speed (wherein N is natural number, N>1) with respect to an information recording medium with a reference recording speed of 1×-speed, the predetermined reference cycle being 1/N times of a reference cycle of the wobble track of the information recording medium with the reference recording speed of 1×-speed.

### BACKGROUND OF THE INVENTION

1. Field of the Invention

The present invention relates to an information recording medium, such as a DVD, for example.

2. Description of the Related Art

In the information recording medium, such as an optical disc, for example, a CD-R/RW (Compact Disc-Recordable/Rewritable), a DVD−R/RW, a DVD+R/RW, DVD-RAM (DVD-Random Access Memory), and the like, the development of the optical disc compatible with a higher recording speed is progressing. For example, the optical disc which allows the record and reproduction of the data at a double speed (or 4 times (4×)-speed, 8×-speed, 16×-speed, etc.) is being developed. These optical discs, which allow the high-speed recording, can be manufactured by changing the properties of raw materials used in the production of the optical discs, or changing pre-recording information, recorded in advance in the optical discs.

### SUMMARY OF THE INVENTION

In the meanwhile, there is developing an optical disc which has wobbled grooves on its recording surface and which has pre-pits, formed in advance, between the grooves at predetermined intervals (Japanese Patent Application Laying Open NO. Hei 9-326138). The wobbles and the pre-pits are read by an information recording/reproducing apparatus, such as a CD player/recorder or a DVD player/recorder. Thus, it is possible to recognize a pre format address on the optical disc, or it is possible to appropriately control the rotation of the optical disc. Specifically, the rotation of the optical disc is controlled so as to match a reference clock owned by the information recording/reproducing apparatus with the cycle of a wobble signal obtained by reading the wobbles.

Here, as the optical disc is associated with the high recording speed, the number of rotations of the optical disc (i.e. the rotation speed) increases. At this time, with the increase of a rotational speed, the frequency of the wobble signal, read by the information recording/reproducing apparatus, increases. In other words, with the increase of the rotational speed, the interval of the read wobbles is shortened, to thereby reduce a time length which can be secured to read the wobbles. Thus, there is a technical problem that the information recording/reproducing apparatus cannot appropriately read the wobbles. In this case, it is considered that it is possible to respond to the high speed recording, by increasing the reference clock owned by the information recording/reproducing apparatus. However, increasing the reference clock means the necessity of high speed signal processing, which requires extremely highly efficient and expensive equipment.

It is therefore an object of the present invention to provide an information recording medium which enables appropriate information recording, in response to high-speed recording, for example.

The above object of the present invention can be achieved by a first information recording medium provided with: a wobble track, which wobbles at a predetermined reference cycle, for controlling rotation of the medium; and a reference recording speed, which is a standard when record information is recorded, being N times speed (wherein N is natural number, N>1) with respect to (in comparison with) an information recording medium with a reference recording speed of 1×-speed, the predetermined reference cycle being 1/N times of a reference cycle of the wobble track of the information recording medium with the reference recording speed of 1×-speed.

According to the first information recording medium of the present invention, in recording the record information, the rotation (or the rotation speed) of the information recording medium is controlled on the basis of the reference cycle of the wobble track. At this time, the rotation of the information recording medium is controlled so as to match the frequency of a signal detected by reading the wobble track with the reference clock generated by an information recording apparatus for recording the record information.

Particularly in the first information recording medium, the reference cycle of the wobble track is formed to be 1/N times of the reference cycle of the wobble track of the information recording medium with the reference recording speed of 1×-speed. Thus, even if the rotational speed of the information recording medium is increased, in order to record the record information at a recording speed of N times (N×) speed, the number of wobbles of the wobble track, which is read by the information recording apparatus, per unit time does not change. Namely, the frequency of the signal detected by reading the wobble track is invariable. Thus, it is possible to record the record information at a high recording speed (i.e. at the N× speed) without changing the reference clock.

It is assumed that the reference cycle of the wobble track formed on the information recording medium with the reference recording speed of N×-speed is equal to the reference cycle of the wobble track formed on the information recording medium with the reference recording speed of 1×-speed. In this case, as the rotational speed of the information recording medium is increased, the number of wobbles of the wobble track, read by the information recording apparatus, per unit time increases. Therefore, without increasing the reference clock (i.e. without increasing the frequency of the reference clock), it is hardly possible to record the record information at a high recording speed.

However, according to the first information recording medium, it is possible to record the record information at a high recording speed without increasing the reference clock. Therefore, there is such an advantage that it is unnecessary to perform high-speed signal processing in response to the high-frequency reference clock. By this, it is possible to exclude such problems as an increase in a processing load of a signal processing circuit and an increase in cost of the signal processing circuit, which is greatly advantageous.

Consequently, according to the first information recording medium of the present invention, it is possible to appropriately record the information in response to the high-speed recording.

In one aspect of the first information recording medium of the present invention, the first information recording medium further provided with an other wobble track wobbles at the reference cycle of the wobble track of the information recording medium with the reference recording speed of 1×-speed.

According to this aspect, on the information recording medium with the reference recording speed of N×-speed, it is possible to form the other wobble track which wobbles at the same reference cycle as that of the wobble track of the information recording medium with the reference recording speed of 1×-speed. Therefore, even if the reference cycle of the wobble track in another area is set to 1/N times, it is possible to appropriately record the data at a high recording speed.

In an aspect of the information recording medium having the different reference cycle of wobbles in the other wobble track, as described above, the other wobble track is formed in a control information area in which control information, which is to control record of the record information onto the information recording medium, is recorded.

By constituting in this manner, even if the reference cycle of the wobble track in an area except the control information area is set to 1/N times, it is possible to appropriately record the data at a high recording speed.

In another aspect of the first information recording medium of the present invention, a pre-pit, which indicates management information necessary for record of the record information onto the information recording medium, is formed on the wobble track, and a standard length in a medium rotational direction of the pre-pit formed on the wobble track, which wobbles at the predetermined reference cycle, is N times as long as a standard length of the pre-pit of the information recording medium with the reference recording speed of 1×-speed.

According to this aspect, it is possible to reduce the recording density of the pre-pit, together with the wobbles, so that it is possible to appropriately record the data at a high recording speed.

In an aspect of the information recording medium in which the pre-pit is formed as described above, a standard length in the medium rotational direction of the pre-pit formed on one portion of the wobble track is equal to the standard length of the pre-pit of the information recording medium with the reference recording speed of 1×-speed.

By constituting in this manner, on the information recording medium with the reference recording speed of N×-speed, it is possible to form the pre-pit having the same length as the standard length of the pre-pit of the information recording medium with the reference recording speed of 1×-speed. Therefore, even if the length of the pre-pit in another area is N times as long, it is possible to appropriately record the data at a high recording speed.

In another aspect of the first information recording medium of the present invention, the wobble track wobbles in such a condition that modulation is applied to the predetermined reference cycle.

According to this aspect, even if Bi Phase Modulation (BPM), which is one specific example of high-frequency modulation, is performed to the wobble track, it is possible to appropriately record the data at a high recording speed.

The above object of the present invention can be also achieved by a second information recording medium, wherein a reference recording speed, which is a standard when record information is recorded, being N times speed (wherein N is natural number, N>1) ; the second information recording medium provided with: a first area in which a wobble track, which wobbles at a first reference cycle, for controlling rotation of the medium is formed; and a second area in which the wobble track which wobbles at a second reference cycle which is 1/N times of the first reference cycle is formed.

According to the second information recording medium of the present invention, the wobble track having the two types of different reference cycles is formed in one information recording medium. Namely, the reference cycle of the wobble track formed in the second area is 1/N times of that of the wobble track formed in the first area. Therefore, in recording various record information into the second area, it is possible to appropriately record the information in response to the high-speed recording, as in the above-described first information recording medium.

It is also possible to appropriately record the various record information in the first area.

Incidentally, in response to various aspects of the first information recording medium of the present invention, the second information recording medium of the present invention can also adopts various aspects.

The nature, utility, and further features of this invention will be more clearly apparent from the following detailed description with reference to preferred embodiment of the invention when read in conjunction with the accompanying drawings briefly described below.

As explained above, according to the first information recording medium of the present invention, the predetermined cycle of the wobble track is 1/N times of that of the wobble track of the information recording medium with the reference recording speed of 1×-speed. Moreover, according to the second information recording medium of the present invention, it is provided with: the first area in which the reference cycle of the wobble track is a first cycle; and the second area in which the reference cycle of the wobble track is 1/N times of the first cycle. Therefore, even at a high recording speed, it is possible to appropriately record the data.

### BRIEF DESCRIPTION OF THE DRAWINGS

FIG. 1 is a diagram showing as an optical disc in a first embodiment of an information recording medium of the present invention, the upper side being a plan view schematically showing a structure of an optical disc having a plurality of areas, in relation to which the lower side is a schematic diagram showing structures of the areas in the radius direction;

FIG. 2 is a partially enlarged perspective view in a recording surface of the optical disc in the first embodiment;

FIG. 3 is an explanatory diagram conceptually showing a relationship among wobbles formed on the optical disc in the first embodiment, a sync frame (i.e. a synchronization frame), a sector, and an ECC (Error Correction Code) block, as being a physical format of the optical disc;

FIG. 4 is an explanatory diagram conceptually showing a relationship among wobbles formed on an optical disc compatible with a reference recording speed of 1×-speed, a sync frame, a sector, and an ECC block, as being a physical format of the optical disc;

FIG. 5 is a table showing a relationship between the reference recording speed and the cycle of the wobble;

FIG. 6 is an explanatory diagram conceptually showing a relationship among wobbles formed on the optical disc in a second embodiment of the information recording medium of the present invention, a sync frame, a sector, and an ECC block, as being a physical format of the optical disc;

FIG. 7 is an explanatory diagram conceptually showing wobbles formed on the optical disc in a third embodiment of the information recording medium of the present invention, and its positional relationship on the optical disc; and

FIG. 8 is a block diagram conceptually showing a basic structure in an embodiment of an information recording/reproducing apparatus for recording data onto the information recording medium of the present invention and reproducing the recorded data.

### DETAILED DESCRIPTION OF THE PREFERRED EMBODIMENTS

Embodiments of the present invention will be explained with reference to the drawings.

Information Recording Medium

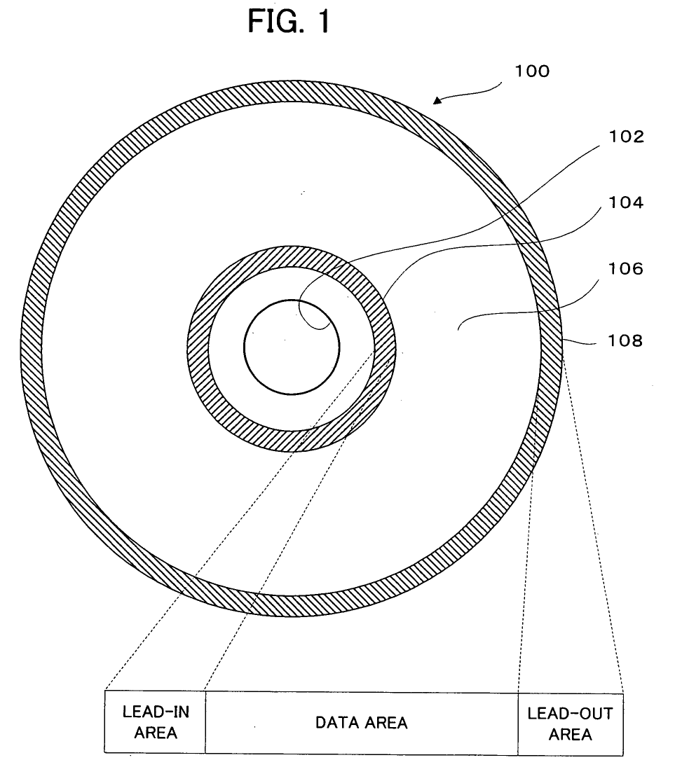

At first, with reference to FIG. 1 to FIG. 7, the embodiments of the information recording medium of the present invention will be explained.

### (1) First Embodiment

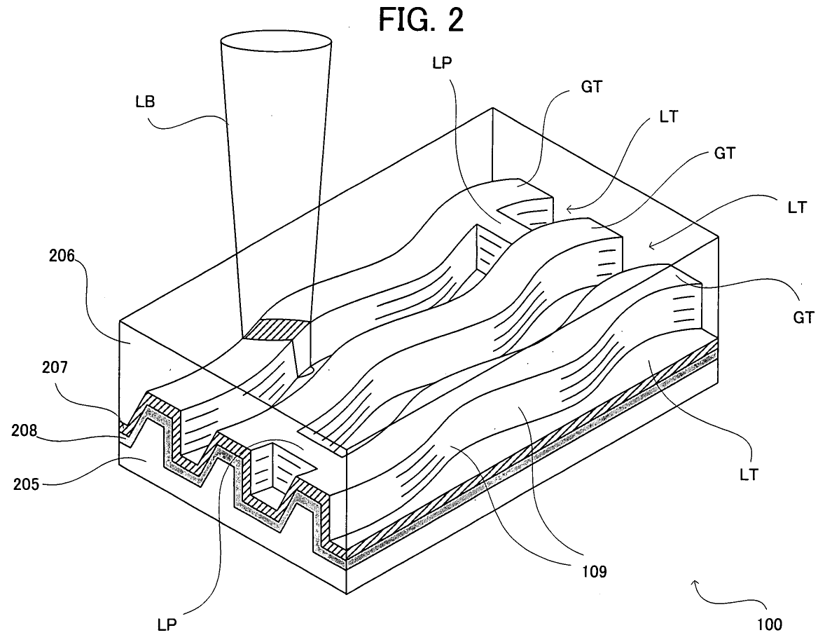

At first, with reference to FIG. 1 to FIG. 5, the first embodiment of the information recording medium of the present invention will be explained. With reference to FIG. 1 and FIG. 2, the outline structure of the information recording medium in the first embodiment is explained. FIG. 1 shows, on the upper side, the structure of an optical disc having a plurality of areas, in relation to which the lower side shows structures of the areas in the radius direction. FIG. 2 shows a recording surface of the optical disc in the first embodiment.

An optical disc 100 is recordable (or writable) many times or only once, in various recording methods, such as a magneto-optical method and a phase change method. The optical disc 100 has a recording surface on a disc main body, with a diameter of about 12 cm, as is a DVD. On the recording surface, as shown in FIG. 1, the optical disc 100 is provided with: a lead-in area 104; a data area 106; and a lead-out area 108, in this order from the inner to the outer circumference, with a center hole 102 as the center. In each area, spirally or concentrically with the center hole 102 as the center, groove tracks and land tracks are placed alternately, for example. The groove tracks may be wobbled. Pre-pits may be formed on either one of or both groove and land tracks.

Incidentally, the present invention is not particularly limited to the optical disc having these three areas. For example, even if the lead-in area 104 and the lead-out area 108 do not exist, a structure explained below can be constructed. Moreover, the lead-in area 104 and the lead-out area 108 may be further divided.

The optical disc 100 in the first embodiment is not limited to an optical disc of a one-layer recording layer type, but may be a two-layer one side type (i.e. a dual layer) or a two-layer double side type (i.e. a dual layer double side). The optical disc 100 is not limited to the optical disc having two recording layers as described above, but may be an optical disc of a multi-layer type, which is a three or more layer type.

As shown in FIG. 2, in the optical disc 100 in the first embodiment, a recording layer 207 of an irreversible change recording type, caused by heat, which constitutes an information recording surface, is laminated on a disc-shaped transparent substrate 206 (on the lower side in FIG. 2), and on top of that (on the lower side in FIG. 2) a reflective film 208 is laminated. Then, on the reflective film 208 (on the lower side in FIG. 2), a protective layer 205 is formed, to thereby protect the optical disc 100 from dusts and scratches from the exterior. On the information recording surface, constructed from the surface of the recording layer 207, groove tracks GT and land tracks LT are formed alternately. Incidentally, in the recording and reproduction on the optical disc 100, as shown in FIG. 2, for example, the groove tracks GT are irradiated with laser light LB through the transparent substrate 206. For example, by the irradiation of the laser light LB with a record laser power, the irreversible change recording, caused by heat or the like, is performed with respect to the recording layer 207, in accordance with the record data. On the other hand, in the reproduction, by the irradiation of the laser light LB with a reproduction laser power which is weaker than the record laser power, the record data written in the recording layer 207 is read out.

The groove tracks GT are wobbled at a certain amplitude and spatial frequency. Namely, the groove tracks GT are wobbled, and the cycle of each wobble 109 is set to a predetermined value. Address pits, referred to as land pre-pits LP, which indicates pre-format address information, are formed on the land tracks LT. By the two addressing (i.e. the wobble 109 and the land pre-pit LP), it is possible to obtain information required for the rotation control of the disc in recording, information required for the generation of the record clock, and information required for the recording of the data, such as a record address. Incidentally, in place of the land pre-pits LP, the wobbles 109 of the groove tracks GT may be modulated by a predetermined modulation method, such as frequency modulation and phase modulation, to thereby record the pre-format address information in advance.

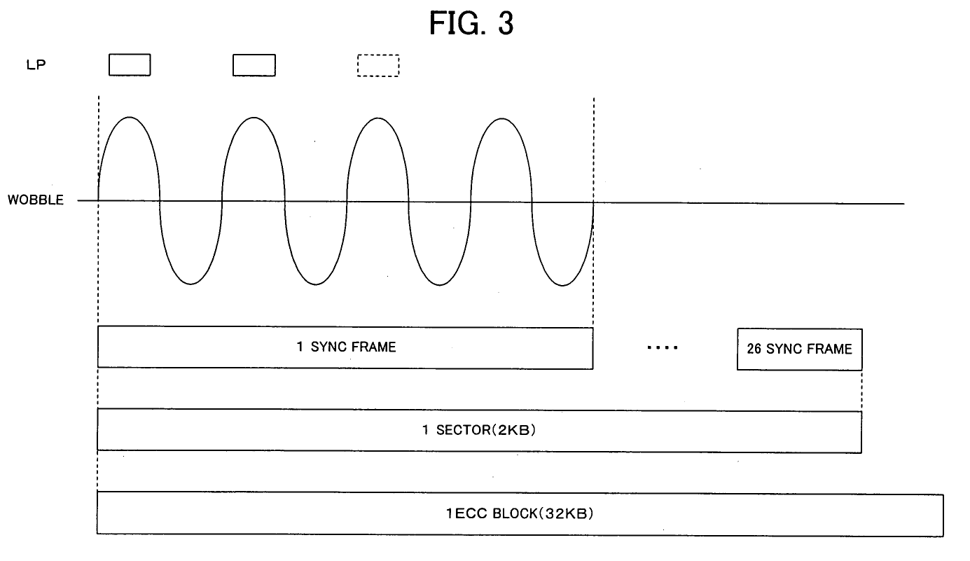

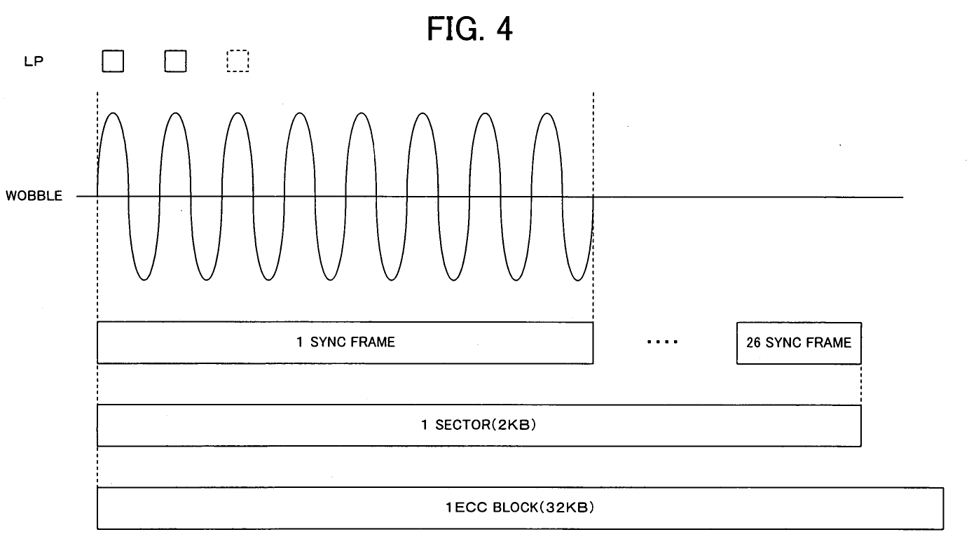

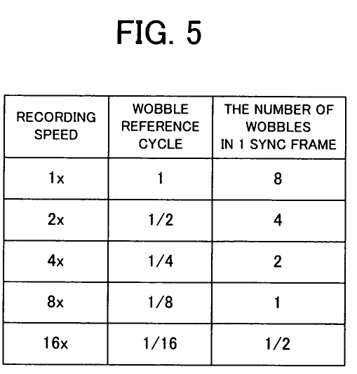

Next, with reference to FIG. 3 to FIG. 5, the information recording medium in the first embodiment will be explained in more detail. FIG. 3 conceptually shows a relationship among wobbles formed on the optical disc in the first embodiment, a sync frame (i.e. a synchronization frame), a sector, and an ECC block, as being a physical format of the optical disc. FIG. 4 conceptually shows a relationship among wobbles formed on an optical disc compatible with a reference recording speed of 1×-speed, a sync frame, a sector, and an ECC block, as being a physical format of the optical disc. FIG. 5 shows a relationship between the reference recording speed and the cycle of the wobble.

Incidentally, the reference recording speed indicates a recording speed which is realized if the rotation of the optical disc is controlled so as to detect a wobble signal having the same cycle (or the same frequency) as that of the reference clock owned by an information recording/reproducing apparatus explained later. Therefore, if the rotation of the optical disc is controlled to make the cycle of the wobble signal or the like, different from the reference clock, it is possible to record the data at a recording speed different from the reference recording speed.

As shown in FIG. 3, as one specific example of the optical disc 100 in the first embodiment, an optical disc with a reference recording speed of double speed (2×-speed) is illustrated for explanation. In the optical disc in the first embodiment, four wobbles 109 per one sync frame are formed. 26 sync frames constitute a sector having a data size of 2 KB. 16 sectors constitute an ECC block having a data size of 32 KB. The land pre-pits LP are formed every two sync frames, at the first three peaks of the wobble 109.

In the optical disc 100 in the first embodiment, as described above, the four wobbles are formed in one sync frame. Namely, the wobbles 109 are formed at a reference cycle at which four-time wobbling is observed in one sync frame. Here, the “reference cycle” indicates a cycle which is a reference or standard for the wobble 109 which wobbles.

Now, in the optical disc with a reference recording speed of 1×-speed, as shown in FIG. 4, eight wobbles 109 are formed in one sync frame. As in the optical disc with a reference speed of 2×-speed, shown in FIG. 3, 26 sync frames constitute a sector having a data size of 2 KB, and 16 sectors constitute an ECC block having a data size of 32 KB. The land pre-pits LP are formed every one sync frames, at the first three peaks of the wobble 109.

Namely, in the optical disc 100 with a reference recording speed of 2×-speed shown in FIG. 3, the number of the wobbles 109 per one sync frame is half, as compared to that of the optical disc with a reference recording speed of 1×-speed shown in FIG. 4. Namely, in the optical disc 100 in the first embodiment, the wobbles 109 are formed to make the reference cycle, at which each wobble 109 wobbles, half.

Moreover, in FIG. 3, the optical disc 100 with a reference recording speed of 2×-speed is illustrated specifically, but even in an optical disc having another reference recording speed, the number of wobbles formed in one sync frame decreases, as compared to that of the optical disc with a reference recording speed of 1×-speed, in the same manner.

Specifically, it is explained with reference to FIG. 5. As shown in FIG. 5, the eight wobble 109 are formed in one sync frame in the optical disc with a reference recording speed of 1×-speed. On the other hand, in the optical disc 100 in the first embodiment, the four wobbles 109 are formed in one sync frame in the case of the optical disc 100 with a reference recording speed of 2×-speed, for example. The reference cycle of this wobble 109 is “½” if the reference cycle of the wobble 109 formed on the optical disc with a reference recording speed of 1×-speed is regarded as “1”. Moreover, in the case of the optical disc 100 with a reference recording speed of 4×-speed, two wobbles 109 are formed in one sync frame, and its reference cycle is “¼”, as compared to that of the optical disc 100 with a reference recording speed of 1×-speed. Moreover, in the case of the optical disc 100 with a reference recording speed of 8×-speed, one wobble 109 is formed in one sync frame, and its reference cycle is “⅛”, as compared to that of the optical disc 100 with a reference recording speed of 1×-speed. Furthermore, in the case of the optical disc 100 with a reference recording speed of 16×-speed, a half wobble 109 is formed in one sync frame (i.e. one wobble 109 is formed in two sync frames), and its reference cycle is “ 1/16”, as compared to that of the optical disc 100 with a reference recording speed of 1×-speed.

In summary, in the optical disc 100 in the first embodiment with a reference recording speed of N×-speed (wherein N is a natural number, N>1), the number of the wobbles 109 formed in one sync frame is “1/N” times of that of the optical disc with a reference recording speed of 1×-speed. Namely, if the number of the wobbles 109 formed in one sync frame is W in the optical disc with a reference recording speed of 1×-speed, the number of the wobbles 109 formed in one sync frame is W/N times in the optical disc 100 in the first embodiment. In other words, if the reference cycle at which the wobble 109 wobbles is T in the optical disc with a reference recording speed of 1×-speed, the reference cycle at which the wobble 109 wobbles is T/N times in the optical disc 100 in the first embodiment.

The following various advantages are achieved by setting the reference cycle, at which the wobble 109 wobbles in the N×-speed optical disc, to 1/N times of that of the optical disc with a reference recording speed of 1×-speed.

It will be specifically explained, along with the operation of the information recording/reproducing apparatus described later, in recording the data onto the optical disc 100 in the first embodiment, for example. The information recording/reproducing apparatus controls the rotation of the optical disc, on the basis of a wobble signal detected from the wobbles 109. For example, it is assumed that a frequency of 140 KHz is used as the reference clock of the information recording/reproducing apparatus. Namely, it is assumed that the peak of the wobble 109 is detected by using a sampling frequency of 140 KHz. At this time, the rotation of the optical disc is controlled to set the cycle of the wobble signal, detected from the wobbles 109, to 140 KHz. The cycle of the wobble signal is a variable, which is determined on the basis of the rotational speed of the optical disc and the reference cycle at which the wobble 109 wobbles.

Now, as in the standard of a DVD or the like, it is assumed that the number of the wobbles 109 per one sync frame does not change (i.e. the reference cycle at which the wobble 109 wobbles is set to be constant) even in the case of the optical disc with a reference recording speed of N×-speed. In order to perform the high-speed recording of the data at the N× recording speed, it is necessary to increase the rotational speed of the optical disc. At this time, since the number of the wobbles 109 per one sync frame is invariable, if only the rotational speed of the optical disc is merely increased, the cycle of the wobble signal increases and does not match the reference clock. Thus, it is necessary to increase the frequency of the reference clock. For example, in order to record the data at a 2× recording speed, the required reference clock is approximately twice as large as the reference clock at a 1× recording speed, namely, approximately 140 KHz×2=280 KHz. Moreover, in order to record the data at a 16× recording speed, the required reference clock is approximately 16 times as large as the reference clock at a 1× recording speed, namely, approximately 140 KHz×16=2.24 MHz. However, as the reference clock increases as described above, the high speed signal processing becomes more necessary on the information recording/reproducing apparatus, to thereby cause problems, such as an increase in a processing load of a signal processing circuit and an increase in cost of the signal processing circuit.

However, according to the optical disc 100 in the first embodiment, if the reference recording speed is the N×-speed, the wobbles 109 are formed to wobble at a reference cycle of 1/N times of a reference cycle at which the wobble 109 wobbles in the optical disc with a reference speed of 1×-speed. Therefore, even in recording the data at the N× recording speed, it is possible to perform the rotation control by using the reference clock of 140 KHz. The reason is as follows. The wobbles 109 are formed so as to set the number of the wobbles 109 to 1/N times of that in the 1×-speed optical disc, and the wobble signal having the same cycle as that of the reference clock is detected, so that the rotational speed of the optical disc automatically increases. For example, in the case of the 2×-speed optical disc 100, the number of the wobbles 109 is ½ times of that of the 1×-speed optical disc. Thus, by multiplying the rotational speed of the optical disc by approximately 2, it is possible to obtain the same wobble signal as that obtained in rotating the 1×-speed optical disc. Alternatively, in the case of the N×-speed optical disc, by multiplying the rotational speed by approximately N, it is possible to obtain the same wobble signal as that obtained in rotating the 1×-speed optical disc. Even if the rotational speed of the optical disc 100 increases, since the number of the wobbles 109 per one sync frame decreases, the cycle of the wobble signal detected is constant, for example, 140 KHz, and it is unnecessary to increase the reference clock. Therefore, in the information recording/reproducing apparatus, it is possible to rotate the optical disc 100 at a high speed without changing the reference clock, i.e. with a reference clock of 140 KHz. As a result, it is possible to perform the high speed recording of the data at a recording speed of N×-speed. By this, the problems, such as an increase in a processing load of a signal processing circuit and an increase in cost of the signal processing circuit, can be dissolved without the necessity of the high speed signal processing, which is greatly advantageous.

In addition, since it is no longer necessary to change the reference clock or the like of the information recording/reproducing apparatus, even into the optical disc with a reference recording speed of N×-speed, which can be developed after the production of the information recording/reproducing apparatus, the data can be recorded at a high speed, i.e. at the N× recording speed. There is also such a great advantage that an appropriate record operation can be performed in a range of specifications, such as an optical pickup for oscillating laser light, a LD driver, and a spindle motor for rotating the optical disc 100.

As shown in FIG. 3, the land pre-pits LP formed on the optical disc 100 with a reference recording speed of N×-speed are also preferably formed to make a standard length (or an average length) in the rotational direction of the optical disc 100, longer than that of the land pre-pits LP formed on the optical disc with a reference recording speed of 1×-speed (refer to FIG. 4). Incidentally, the “standard length” indicates a unit length of the length of the pre-pit. Specifically, the standard length in the rotational direction of the land pre-pits LP is preferably long enough to set the density of the land pre-pits, formed on the optical disc with a reference recording speed of N×-speed, to 1/N times of the density of the optical disc with a reference recording speed of 1×-speed. For example, the standard length of the pre-pit on the optical disc with a reference recording signal of N×-speed may be formed to be N times as long as the standard length of the pre-pit on the optical disc with a reference recording speed of 1×-speed.

Incidentally, in the optical disc 100 in the first embodiment, the recording of the address information and the rotation control of the optical disc are performed by virtue of the wobbles 109 and the land pre-pits LP. More specifically, a DVD-R/RW can be listed as one specific example, for example.

### (2) Second Embodiment

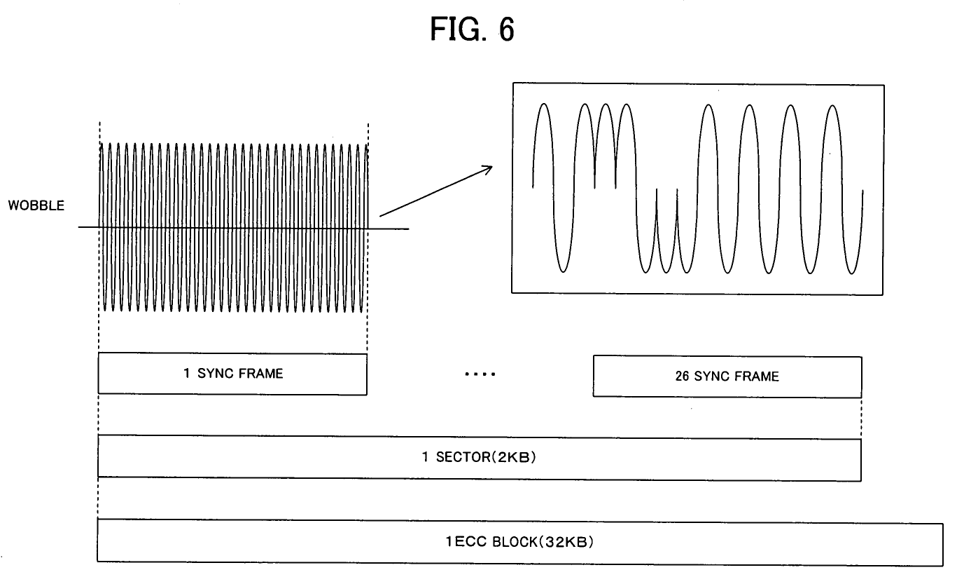

Next, with reference to FIG. 6, the second embodiment of the information recording medium of the present invention will be explained in more detail. FIG. 6 conceptually shows a relationship among wobbles formed on the optical disc in the second embodiment of the information recording medium of the present invention, a sync frame, a sector, and an ECC block, as being a physical format of the optical disc.

Incidentally, an optical disc 100a in the second embodiment also has such a structure as explained with reference to FIG. 1 and FIG. 2. Particularly in the second embodiment, as shown in FIG. 6, Bi Phase Modulation (BPM) is performed with respect to the wobbles 109 which wobble at the reference cycle. By performing BPM to the wobbles 109 as described above, it is possible to record the pre-format address information, as in the land pre-pits LP in the first embodiment.

In such BPM, generally, the reference cycle of the wobbles 109 has a large numerical value. For example, in a DVD+R as being one specific example of the optical disc on which BPM is performed to the wobbles 109, the reference cycle of the wobbles 109 formed on the optical disc with a reference recording speed of 1×-speed is 840 KHz. For example, in the case of the optical disc with a reference recording speed of 16×-speed, the required reference clock is approximately 16 times as large as the reference clock of the 1× recording speed optical disc, namely, approximately 840 KHz×16=13.44 MHz. In addition, if BPM is performed, the wobble signal shows the data every half wave, so that the required reference clock is further doubled, namely, 13.44 MHz×2=26.88 MHz. However, such high frequency sampling of approximately 26 MHz requires extremely advanced signal processing, and causes a great increase in a processing load of a signal processing circuit and a great increase in cost of the signal processing circuit.

However, the optical disc 100a in the second embodiment with a reference recording speed of N×-speed has the wobbles 109 formed thereon, which have a reference cycle of 1/N times of that of the wobbles 109 of the optical disc with a reference recording speed of 1×-speed. Therefore, as described in the first embodiment, in the information recording/reproducing apparatus, it is possible to rotate the optical disc 100 at a high speed without changing the reference clock, i.e. with a reference clock of 840 KHz. As a result, it is possible to perform the high speed recording of the data at a recording speed of N×-speed. Particularly, in the optical disc having the wobbles 109 to which BPM is performed, the high frequency reference clock is generally required, so that changing the reference cycle of the wobbles 109 leads to an extremely great advantage. Then, it is possible to receive various benefits as described in the first embodiment.

Incidentally, in the second embodiment, the recording of the address information and the rotation control of the optical disc are performed by virtue of the wobbles 109 and the modulation performed to the wobbles 109. More specifically, a DVD+R/RW and a DVD-RAM can be listed as one specific example, for example. Moreover, the modulation performed to the wobbles 109 is not limited to BPM, but may be various modulation methods including various methods using Frequency Modulation (FM), various methods using Amplifier Modulation (AM), and another various methods using Phase Modulation (PM), and the like. Regardless of these various methods of modulation, which is performed to wobble 109 on the basis of the reference cycle, according to the second embodiment, it is possible to receive the above-described various benefits without changing the reference cycle.

### 3 Third Embodiment

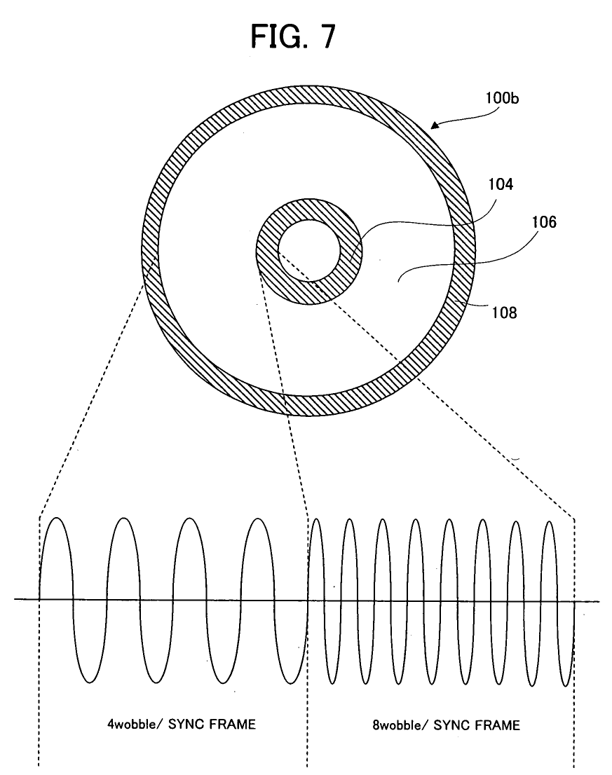

Next, with reference to FIG. 7, the third embodiment of the information recording medium of the present invention will be explained in more detail. FIG. 7 conceptually shows wobbles formed on the optical disc in the third embodiment of the information recording medium of the present invention, and its positional relationship on the optical disc.

Incidentally, an optical disc 100b in the third embodiment also has such a structure as explained with reference to FIG. 1 and FIG. 2. Particularly in the third embodiment, as shown in FIG. 7, a plurality of types of wobble 109 with different cycles are formed in one optical disc. Specifically, if the reference recording speed of the optical disc 100b in the third embodiment is the 2×-speed, eight wobbles 109 per one sync frame are formed in the lead-in area 104, while four wobbles 109 per one sync frame are formed in the data record area 106. Namely, in the lead-in area 104, the wobbles 109 are formed as in the optical disc with a reference recording speed of 1×-speed. On the other hand, in the data area 106, the wobbles 109 are formed at a reference cycle of ½ times of that of the wobbles 109 formed on the optical disc with a reference recording speed of 1×-speed.

In this manner, the cycle of the wobbles may be changed in one optical disc 100b. In this case, the rotational speed of the optical disc 100b is changed, as occasion demands, in accordance with the wobble signal. Particularly in recording the data into the data area 106, it is possible to realize the record operation at a high recording speed. Moreover, there is such an advantage that it is unnecessary to change the reference clock throughout the optical disc 100b.

Incidentally, the wobbles are not necessarily formed throughout the lead-in area 104 as in the optical disc with a reference recording speed of 1×-speed. For example, at least in a control data zone, the wobbles 109 may be formed which have the same reference cycle as that of the optical disc with a reference recording speed of 1×-speed. Alternatively, in a predetermined area other than the control data zone, the wobbles 109 may be formed which have the same reference cycle as that of the optical disc with a reference recording speed of 1×-speed. Moreover, it is obvious that not only in the 2×-speed optical disc, but also in the N×-speed optical disc, the same structure as that of an optical disc 100b in the third embodiment can be adopted. Namely, the cycle of the wobbles 109 formed in the data area 106 may be 1/N times of that of the wobbles 109 formed in the lead-in area 104 (i.e. at least the control data zone).

Moreover, the wobbles 109 may be formed to wobble at different cycles even in one sync frame. If the two types of wobble which wobbles at different cycles are formed in one sync frame, for example, any one of the cycles may be regarded as the reference cycle. Furthermore, wobble tracks (i.e. several types of wobble) having three or more different reference cycles may be formed in one optical disc.

Incidentally, in the above-described various embodiments, the reference cycle of the wobbles 109 of the optical disc with a reference recording speed of 1×-speed, or the like is used as the reference cycle (or the number) of the wobbles 109 which is a standard, but it is not limited to this. For example, it is possible to use the reference cycle of the wobbles 109 of the optical disc with a reference recording speed of 2×-speed, or the like as standard. For example, in the optical disc with a reference recording speed of 2×-speed, the reference cycle of the wobbles 109 which makes the reference clock 280 KHz may be used as the standard. Specifically, if one sync frame in which eight wobbles 109 are formed is regarded as the standard in the optical disc with a reference recording speed of 2×-speed, four wobbles 109 are formed in one sync frame in the optical disc with a reference recording speed of 4×-speed, for example. Moreover, one wobble 109 is formed in one sync frame in the optical disc with a reference recording speed of 16×-speed, for example. As described above, it is possible to use the various recording speed other than 1×-speed (or various reference clock), as the standard.

Incidentally, the recording speed described in the above explanation may be an absolute recording speed, or a relative recording speed. In the case of the relative recording speed, as long as a predetermined speed is set to be the 1×-speed, it is possible to define the 2×-speed, 4×-speed, and the like, with respect to the recording speed. For example, if “1 Mbps” is set to be the 1×-speed, a 4× recording speed may be constructed to be “4 Mbps”. Or if “2 Mbps” is set to be the 1×-speed, a 4× recording speed may be constructed to be “8 Mbps”.

(Information Recording/Reproducing Apparatus)

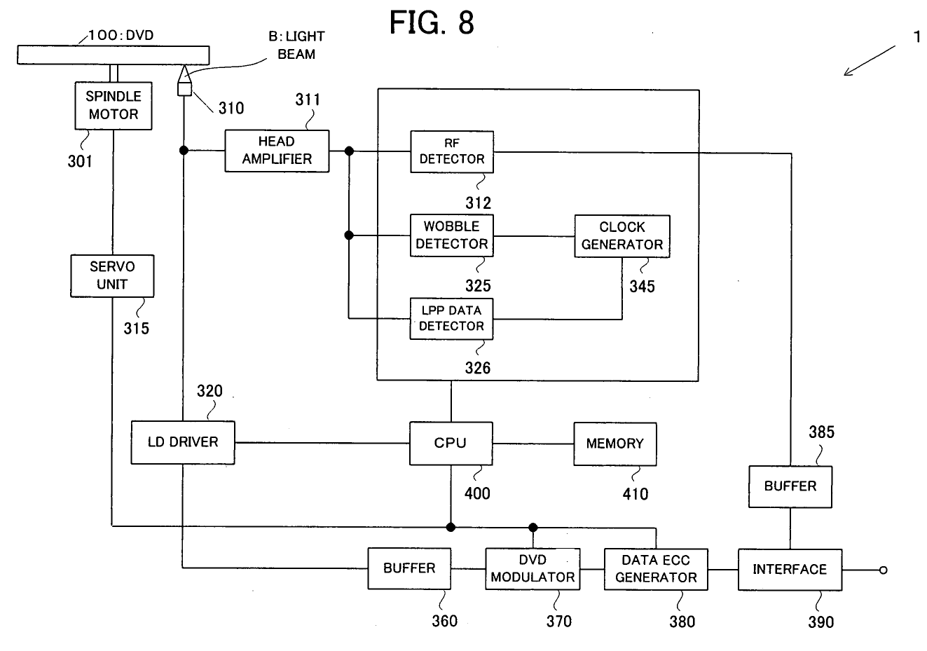

Next, with reference to FIG. 8, the embodiment of the information recording/reproducing apparatus, which records data onto the information recording medium in each embodiment of the present invention and which reproduces the recorded data, will be explained. FIG. 8 conceptually shows a basic structure in the embodiment of an information recording/reproducing apparatus for recording data onto the information recording medium in each embodiment of the present invention and reproducing the recorded data.

As shown in FIG. 8, an information recording/reproducing apparatus 1 in the embodiment is provided with: a spindle motor 301; an optical pickup 310; a head amplifier 311; a Radio Frequency (RF) detector 312; a servo unit 315; a Laser Diode (LD) driver 320; a wobble detector 325; a Land Pre-Pit (LPP) data detector 326; a clock generator 345; a buffer 360; a DVD modulator 370; a data ECC generator 380; a buffer 385; an interface 390; a Central Processing Unit (CPU) 400; and a memory 410.

The spindle motor 301 is constructed to rotate the optical disc 100 at a predetermined speed while receiving spindle servo from the servo unit 315 or the like.

The optical pickup 310 performs the recording or reproduction with respect to the optical disc 100, and is constructed from a semiconductor laser apparatus, various lenses, an actuator, and the like. More specifically, the optical pickup 310 irradiates the optical disc 100 with a light beam, such as laser light, with a first power as reading light (reproduction light) in the reproduction, and with a second power as writing light (recording light) in the recording, while modulating the light beam. The optical pickup 310 is constructed to be displaced in the radial direction of the optical disc 100 or the like, by a not-illustrated actuator, slider, and the like, which are driven by the servo unit 315.

The head amplifier 311 amplifies an output signal of the optical pickup 310 (i.e. reflected light of a light beam B) and outputs the amplified signal. Specifically, the head amplifier 311 outputs a RF signal, as being a reading signal, to the RF detector 312 and an envelope detector (not illustrated), and outputs a push-pull signal to the wobble detector 325 and the LPP data detector 326.

The RF detector 312 is constructed to detect and demodulate the RF signal, to thereby output reproduction data to the exterior through the buffer 385 and the interface 390. Then, on external output equipment connected to the interface 390 (e.g. a display device, such as a liquid crystal display and a plasma display, or a speaker, or the like), predetermined contents are reproduced and outputted.

The servo unit 315 displaces an object lens of the optical pickup 310, on the basis of a tracking error signal, a focus error signal, and the like, which are obtained by processing the output signal corresponding to the amount of received light from the head amplifier 311, to thereby perform various servo processing, such as tracking control and focus control. Moreover, the servo unit 315 is constructed to servo-control the spindle motor 301 on the basis of a wobble signal obtained from wobbles of wobbling group tracks on the optical disc 100.

The LD drive 320 is constructed to drive a semiconductor laser of the optical pickup 310, with an optimum recording laser power determined by Optimum Power Control (OPC) in the data recording. In the data recording, the recording laser power is modulated in accordance with the record data.

The wobble detector 325 is constructed to detect a push-pull signal, which indicates the wobble signal, and to output the wobble signal to the clock generator 345, on the basis of an output signal corresponding to the amount of received light from the head amplifier 311, as being a detector, which is placed in the optical pickup 310, for receiving a reflected light beam.

The LPP data detector 326 is constructed to detect a push-pull signal, which indicates a LPP signal, and to detect the pre-format address information, as described later, for example, on the basis of an output signal corresponding to the amount of received light from the head amplifier 311, as being a detector, which is placed in the optical pickup 310, for receiving a reflected light beam. The LPP data detector 326 is also constructed to output the pre-format address information to the clock generator 345.

The clock generator 345 generates a reference clock in recording, and compares it with the cycle of the wobble signal obtained from the wobble detector 325. Then, the rotation of the optical disc 100 is controlled by the spindle motor 301, under the control of the CPU 400, so as to match the cycle of the wobble signal with the reference clock.

The buffer 360 is constructed to store the record data modulated by the DVD modulator 370 to output it to the LD driver 320.

The DVD modulator 370 is constructed to perform DVD modulation with respect to the record data (to which the ECC code as described later is added), and to output it to the buffer 360. As the DVD modulation, for example, 8-16 modulation and Run Length Limiter (RLL) modulation may be performed.

The data ECC generator 380 appends a code for error correction, to the record data inputted from the interface 390. Specifically, the data ECC generator 380 appends an ECC code for each predetermined block unit (e.g. an ECC block unit), and outputs the record data with the ECC code to the DVD modulator 370.

The buffer 385 stores therein the reproduction data outputted from the RF detector 312, and outputs it to the external output equipment through the interface 390.

The interface 390 receives an input of the record data or the like, from external input equipment, and outputs it to the data ECC generator 380. Moreover, the interface 390 may be constructed to output the reproduction data outputted from the RF detector 312 through the buffer 385, to the external output equipment, such as a speaker and a display.

The CPU 400 controls the information recording/reproducing apparatus 1 as a whole, by giving an instruction to each device, i.e. by outputting a system command to each device, such as the LD driver 320 and the servo unit 315, in order to control whole of the information recording/reproducing apparatus 1. Typically, software for the CPU 400 operating is stored in an internal or external memory.

The memory 410 includes a semiconductor memory, such as a RAM and a flush memory, and is constructed to record a correlation equation and a value of the recording laser power. Furthermore the memory 410 is used as buffer temporarily storing various data/parameter/variant for controlling the information recording/reproducing apparatus 1.

The information recording/reproducing apparatus 1 records the data onto the optical disc in the above-described embodiments, and reproduces the recorded data. Specifically, the wobble signal, which is obtained by irradiating the wobbles 109 with laser light, is detected by the wobble detector 325 though the head amplifier 311. Moreover, by the operation of the clock generator 345, the reference clock in the data recording is generated. Then, the rotation of the optical disc 100 is controlled so as to match the cycle of the wobble signal with the reference clock. Specifically, under the control of the CPU 400, which receives the data for controlling from both the wobble detector 325, the clock generator 345, and the like, the output of the spindle motor 301 is adjusted through the servo unit, which realizes a desired rotational speed.

As a result, as described above, even in the optical disc 100 with a reference recording speed of N×-speed, it is possible to perform the high speed recording of the data at the N× recording speed without increasing the reference clock. By this, the problems, such as an increase in a processing load of a signal processing circuit and an increase in cost of the signal processing circuit, can be dissolved without the necessity of the high speed signal processing, which is greatly advantageous.

Incidentally, the reference recording speed of the optical disc 100, loaded into the information recording/reproducing apparatus 1, may be judged by the rotational speed (or the number of rotations) when the optical disc 100 is rotated by using the reference clock. Alternatively, if the data for indicating the reference recording speed is recorded on the optical disc 100, the reference recording speed may be judged by reading the data.

Moreover, in the above-described embodiments, the optical disc 100 is explained as one example of the information recording medium, and a recorder/player associated with the optical disc 100 is explained as one example of the information recording/reproducing apparatus. The present invention, however, is not limited to the optical disc and the recorder/player thereof, but can be applied to other various information recording medium, in response to high density recording or a high transmission rate.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-026707 filed on Feb. 3, 2004 including the specification, claims, drawings and summary is incorporated herein by reference in its entirety.

1. An information recording medium comprising:
a wobble track, which wobbles at a predetermined reference cycle, for controlling rotation of the medium; and
a reference recording speed, which is a standard when record information is recorded, being N times speed (wherein N is natural number, N>1) with respect to an information recording medium with a reference recording speed of 1×-speed,
the predetermined reference cycle being 1/N times of a reference cycle of the wobble track of the information recording medium with the reference recording speed of 1×-speed.

2. The information recording medium according to claim 1, further comprising an other wobble track wobbles at the reference cycle of the wobble track of the information recording medium with the reference recording speed of 1×-speed.

3. The information recording medium according to claim 2, wherein the other wobble track is formed in a control information area in which control information, which is to control record of the record information onto the information recording medium, is recorded.

4. The information recording medium according to claim 1, wherein
a pre-pit, which indicates management information necessary for record of the record information onto the information recording medium, is formed on the wobble track, and
a standard length in a medium rotational direction of the pre-pit formed on the wobble track, which wobbles at the predetermined reference cycle, is N times as long as a standard length of the pre-pit of the information recording medium with the reference recording speed of 1×-speed.

5. The information recording medium according to claim 4, wherein a standard length in the medium rotational direction of the pre-pit formed on one portion of the wobble track is equal to the standard length of the pre-pit of the information recording medium with the reference recording speed of 1×-speed.

6. The information recording medium according to claim 1, wherein the wobble track wobbles in such a condition that modulation is applied to the predetermined reference cycle.

7. An information recording medium, wherein a reference recording speed, which is a standard when record information is recorded, being N times speed (wherein N is natural number, N>1) ; said information recording medium comprising:
a first area in which a wobble track, which wobbles at a first reference cycle, for controlling rotation of the medium is formed; and
a second area in which the wobble track which wobbles at a second reference cycle which is 1/N times of the first reference cycle is formed.
